(19) United States
(12) Patent Application Publication
(10) Pub. No.: US 2009/0153850 A1
(43) Pub. Date: Jun. 18, 2009

(54) OPTICAL FLUORESCENCE TOMOGRAPHY CALIBRATION

(75) Inventors: Tim Nielsen, Hamburg (DE); Thomas Koehler, Norderstedt (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/304,276

(22) PCT Filed: Jun. 13, 2007
(86) PCT No.: PCT/IB2007/052230

§ 371 Date: Dec. 11, 2008

(30) Foreign Application Priority Data
Jun. 14, 2006 (EP) 06115450.6

(51) Int. Cl. G01J 1/10; G01J 1/58

(52) U.S. Cl. 356/243.1; 250/458.1

(57) ABSTRACT

The invention relates to a device for imaging an interior of a turbid medium and a medical image acquisition device comprising: a) a measurement volume (15) for accommodating the turbid medium (45); b) a light source (5) for irradiating the turbid medium (45); c) a photodetector unit 10 for detecting light emanating from the measurement volume (15). The device for imaging an interior of the turbid medium and the medical image acquisition device are adapted such that the devices further comprise a calibration device (55, 60) arranged to be optically coupled to the measurement volume (15) and comprising a calibration light source (65) arranged to simultaneously generate the excitation light and further light corresponding to the fluorescence light. The invention also relates to a calibration device (60) arranged to be inserted into a receptacle (20) that comprises a measurement volume (15) for receiving a turbid medium (45) in a device for imaging an interior of a turbid medium (45), having a contact part (70) comprising a contact surface (75) that fits at least a part of the surface of the receptacle (20) facing the measurement volume (15), and having a calibration light source (65) arranged to simultaneously generate light that causes fluorescent emission in a fluorescent agent present in the turbid medium and further light corresponding to the fluorescence light. The contact part (70) may be removable.

The invention relates to a device for imaging an interior of a turbid medium comprising:

a) a measurement volume for accommodating the turbid medium;
b) a light source for irradiating the turbid medium;
c) a photodetector unit for detecting light emanating from the measurement volume.

The invention also relates to a medical image acquisition device comprising:

a) a measurement volume for accommodating the turbid medium;
b) a light source for irradiating the turbid medium;
c) a photodetector unit for detecting light emanating from the measurement volume.

The invention also relates to a calibration device comprising a calibration light source and arranged to be inserted into a receptacle comprising a measurement volume for receiving a turbid medium in a device for imaging an interior of the turbid medium and comprising a contact part comprising a contact surface that fits at least a part of the surface of the receptacle facing the measurement volume.

An embodiment of a device of this kind is described in European patent application 05111164.9 (PH004270 attorney reference). The described device can be used for imaging an interior of an optically turbid medium, such as biological tissues. In medical diagnostics the device may be used for imaging tumors in breast tissue or for imaging rheumatoid arthritis in joints. A turbid medium, such as a breast, is accommodated inside a measurement volume and irradiated with excitation light from a light source. Typically, in medical diagnostics light having a wavelength within the range of 400 nm to 1400 nm is used. The excitation light is chosen such that it causes fluorescent emission in a fluorescent agent in the turbid medium. Excitation light and fluorescence light emanating from the measurement volume as a result of irradiating the turbid medium are detected and used to derive an image of an interior of the turbid medium. The measurement volume may be bound by a holder having only one open side, with the open side being bound by an edge portion. This edge portion may be provided with an elastically deformable sealing ring. Such a holder is known from U.S. Pat. No. 6,480,281 B1.

The invention provides an improved device of the kind set forth. This improvement is realized by a measure characterized in that the device further comprises a calibration device arranged to be optically coupled to the measurement volume and comprising a calibration light source arranged to simultaneously generate the excitation light and further light corresponding to the fluorescence light. Thus, an easy means for performing a calibration measurement to determine the relative sensitivity of a detector for excitation light and fluorescence light is provided.

The invention is based on the recognition that a measurement involving fluorescence light requires an optical fluorescence tomography calibration, because the relative sensitivity of a detector for excitation light and fluorescence light is required as a calibration factor. Without calibration proper image reconstruction is difficult. After all, different detectors may have different sensitivities for the same signal. Correctly performing the image reconstruction may benefit from knowledge of these different sensitivities.

Clearly, the described device is suitable for irradiating the turbid medium with light having optical properties chosen such that the light can propagate through the turbid medium. The light detected during such a transmission measurement is then used to reconstruct an image of an interior of the turbid medium. If two measurements are performed, one with a turbid medium and a matching medium present in the measurement volume, and one without a turbid medium present in the measurement volume but with a matching medium, no explicit calibration of the device is required if the intensity of light detected in one measurement is divided through the intensity of light detected in the other measurement. This can be clarified as follows. For a transmission measurement the device may comprise a laser as a light source for irradiating the turbid medium from a plurality of source positions, an optical switch for optically coupling the light source to a selected opening selected from the plurality of openings, optical fibers for optically coupling the optical switch to the measurement volume, a photodetector unit for detecting light emanating from the measurement volume from a plurality of detection positions, further optical fibers for optically coupling the measurement volume to the photodetector unit, and optical filters for the photodetector unit. The intensity of light detected in a measurement with a turbid medium and a matching medium present can then be modeled as:

I^{x}(s,d)=Lw(s)T^{s}(s)c^{s}(s)Φ^{x}(s,d)c^{d}(d)T^{d}(d)F^{x}(d)ρ(d).

In this equation s represents a source at source position s, d represents a detector at detection position d and I^{x}(s,d) the intensity of light detected at detection position d with source position s active,

L the laser intensity,
w(s) the transmission of the optical switch for setting s,
T^{s}(s) the transmission of the source fiber to source position s,
c^{s}(s) the transmission of the fiber/turbid medium interface for source position s,
Φ^{x}(s,d) the transmission of the turbid medium together with the matching medium,
c^{d}(d) the transmission of the fiber/turbid medium interface for detector position d,
T^{d}(d) the transmission for the detection fiber to detection position d,
F^{x}(d) the transmission of the filter for the detector at detection position d,
ρ(d) the detection sensitivity of the detector at detection position d.

The superscript x indicates a measurement involving light having optical properties chosen such that the light can propagate through the turbid medium.

The intensity of light detected in a measurement with only a matching medium present can then be modeled as:

I^{x}ₒ(s,d)=Lw(d)T^{s}(s)c^{s}(s)Φ^{x}ₒ(s,d)c^{d}(d)T^{d}(d)F^{x}(d)ρ(d).

Here, the subscript o indicates a measurement with only a matching medium present in the measurement volume.

If the intensity of the laser is assumed to be constant, only the ratio of the transmission of the turbid medium plus the matching medium and the transmission of the matching medium remains, if the intensity of light detected in one measurement is divided through the intensity of light detected in the other measurement. Therefore, no explicit calibration of the device is required in this situation.

However, if a fluorescent agent is present in the turbid medium, only the first four factors on the right side of the equal sign cancel if the ratio is calculated of a measurement involving both excitation light and fluorescence light and of a measurement involving only excitation light. This ratio then becomes:

$$\frac{{I}^{f} ( s , d )}{{I}^{x} ( s , d )} = \frac{{Φ}^{f} ( s , d ) {c}^{df} ( d ) {T}^{df} ( d ) {F}^{f} ( d ) {σ}^{f} ( d )}{{Φ}^{x} ( s , d ) {c}^{d} ( d ) {T}^{d} ( d ) {F}^{x} ( d ) {σ}^{x} ( d )} = \frac{{Φ}^{f} ( s , d )}{{Φ}^{x} ( s , d )} * {ξ}_{d}$$

Here, the superscript x indicates a measurement in which both excitation light and fluorescence light is detected. The superscript f indicates a measurement in which only fluorescence light is detected through use of a filter through which only the fluorescence light can pass. Clearly, in this situation not only the ratio of the transmission of the turbid medium plus the matching medium and the transmission of the matching medium only remains, but also an additional calibration factor ξ_{d} that needs to be determined. The additional calibration factor comprises various factors relating to various elements of the device.

The calibration factor can be determined using a special calibration device arranged to simultaneously generate the excitation light and further light corresponding to the fluorescence light. Let the spectrum of the light generated by the calibration device be:

S(λ)=pS^{x}(λ)+qS^{f}(λ),

where S^{x} is the spectrum of the excitation light source and S^{f} is the fluorescence spectrum. A measurement with (I_{f}) and without (Iₓ) a fluorescence filter would give the following values:

I^{x}=F^{x}(S)ρ^{x}(S)=p*c^{dx}(S^{x})T^{dx}(S^{x})F^{x}(S^{x})ρ^{x}(S^{x})+q*c^{dx}(S^{f})T^{dx}(S^{f})F^{x}(S^{f})ρ^{x}(S^{f})

I_{f}=F^{f}(S)ρ^{f}(S)=p*c^{df}(S^{x})T^{df}(S^{x})F^{f}(S^{x})ρ^{f}(S^{x})+q*c^{df}(S^{f})T^{df}(S^{f})F^{f}(S^{f})ρ^{f}(S^{f})

If the relative contributions of the excitation light and the fluorescence light in S are such that p>>q and the rejection of the filter for the excitation light is high enough (p*F^{f}(S^{x})<<q*F^{f}(S^{f})) this becomes:

Iₓ=p*c^{dx}(S^{x})T^{dx}(S^{x})F^{x}(S^{x})ρ^{x}(S^{x})

I_{f}=p*c^{df}(S^{f})T^{df}(S^{f})F^{f}(S^{f})ρ^{f}(S^{f})

If the rejection of the fluorescence filter is known, the calibration can also be done for light sources that do not fulfill these inequalities. The calibration factor ξ_{d} can be calculated from the ratio of both measurements and the spectral composition of the source:

$${ξ}_{d} = \frac{{c}^{df} ( d ) {T}^{df} ( d ) {F}^{f} ( d ) {σ}^{f} ( d )}{{c}^{dx} ( d ) {T}^{dx} ( d ) {F}^{x} ( d ) {σ}^{x} ( d )} = \frac{p {I}_{f} ( d )}{q {I}_{x} ( d )}$$

p and q need not be known explicitly. If the ratio

I_{f}/Iₓ=r,

then the mean value rₘ of r can be written as:

$${r}_{m} = \frac{1}{{n}_{d}} \sum {r}_{i} = \frac{q}{p} * \frac{1}{{n}_{d}} \sum {ξ}_{i}$$

where n_{d} is the number of detectors and the index i indicates a particular detector (i=1, . . . , n_{d}).

The right-hand side of the last equation can also be written as:

q/p*ξₘ,

where ξₘ indicates the mean value of all δᵢ (i=1, . . . , n_{d}). This mean value is known from the design of the system as it may depend on, for instance, the choice of photodiodes, the choice of optical filters, etc. Combining the last two equations results in:

q/p=rₘ/ξₘ

Hence, the following equation holds for ξᵢ:

ξᵢ=ξₘ/rₘ*rᵢ.

From this equation it is clear that the required calibration factors ξᵢ can be obtained by performing measurements with and without a fluorescence filter coupled to the i-th detector and combining the measured data with prior knowledge about the system. This is still true even if the relative level of laser and fluorescence light of the calibration light source changes with time. If the rejection of the filter for laser light is not high enough the last equation becomes:

ξᵢ=ξₘ*(rᵢ−c)/(rₘ−c),

where c equals c^{df}(S^{f})T^{df}(S^{f})F^{f}(S^{f})/c^{dx}(S^{x})T^{dx}(S^{x})F^{x}(S^{x})

An embodiment of the device according to the invention is characterized in that the calibration device comprises a fluorescent dye. Conceivably, the calibration device could be arranged to comprise a calibration light source arranged to generate light having characteristics corresponding to, but not necessarily equal to those of the fluorescence light emitted by the fluorescent agent present in the turbid medium. However, if the fluorescent dye comprised in the calibration device is the same dye as the fluorophore in the fluorescent agent present in the turbid medium this embodiment has the advantage that the fluorescence light generated in the calibration device is, almost by definition, exactly the same as the fluorescence light generated inside the turbid medium. Ideally, the fluorescent dye comprised in the calibration device and the fluorescent agent present in the turbid medium are one and the same substance. However, there may be considerations, for instance, cost considerations resulting in only the fluorophore-part of the fluorescent agent being used in the calibration device.

A further embodiment of the device according to the invention is characterized in that the fluorescent dye is comprised inside a dye volume having boundaries facing the dye volume that have optical characteristics chosen such that the boundaries reflect the excitation light. As the boundaries have optical characteristics chosen such that they reflect the excitation light, this embodiment has the advantage that the path traveled by the excitation light inside the volume comprising the fluorescent dye is lengthened. As a result, more fluorescence light is generated inside the dye volume as, because of the lengthened path, the excitation light encounters more of the fluorescent dye than if the path were shorter.

A further embodiment of the device according to the invention is characterized in that the calibration device further comprises adjusting means arranged to adjust the relative intensities of the excitation light and the fluorescence light generated by the calibration device. As explained previously, the calibration process can be simplified if the relative contribution of the excitation light to the light generated by the calibration device is much larger than that of the fluorescence light. Therefore, the calibration process can benefit from adjusting means allowing the relative intensities of the excitation light and the fluorescence light generated by the calibration device to be adjusted. Depending on which contribution is stronger and on how one wants to adjust the relative intensities of the excitation light and the fluorescence light, various options exist. If, for instance, the intensity of the excitation light is much higher than the intensity of the fluorescence light and one wants to have intensities of the same order of magnitude a filter for filtering out at least part of the excitation light may be used. Alternatively, a substance may be added to the fluorescent dye having optical characteristics chosen such that the substance absorbs the excitation light more strongly than the fluorescence light.

A further embodiment of the device according to the invention is characterized in that the calibration device is arranged to be inserted into the device. If, for instance, the calibration device comprises a fluorescent dye this embodiment has the advantage that a calibration device comprising one fluorescent dye can be easily exchanged for a calibration device comprising another fluorescent dye and that it allows easy cleaning of the volume comprising the fluorescent dye comprised in the calibration device.

A further embodiment of the device according to the invention is characterized in that the device further comprises a receptacle comprising the measurement volume for accommodating the turbid medium, said receptacle comprising optical channels for optically coupling the light source to the measurement volume and the measurement volume to the photodetector unit, the calibration device being arranged to be inserted into the receptacle and the calibration device comprising a contact part comprising a contact surface that fits at least a part of the surface of the receptacle facing the measurement volume. If the calibration device fits at least a part of the surface of the receptacle facing the measurement volume the calibration device can be arranged such that the light generated by the calibration device reaches all detection positions with the same composition. Because of the close fit, the calibration device can be easily inserted into the receptacle.

A further embodiment of the device according to the invention is characterized in that the contact part is removable. This embodiment has the advantage that it allows the use of different contact parts that have different dimensions.

A further embodiment of the device according to the invention is characterized in that the contact part comprises a surface bounding a contact part volume and facing the calibration light source, said surface having optical characteristics chosen such that the surface reflects the excitation light and the fluorescence light, the surface comprising further optical channels for optically coupling the calibration device to selected optical channels. This embodiment has the advantage that it allows the light generated by the calibration device to reach all detection positions with the same intensity and the same composition. This result is reached in that the surface bounding a volume, facing the calibration source, and reflecting the light generated by the calibration device leads to multiple reflections of the light generated by the calibration device inside the bounded volume. The light coupled to selected optical channels via further optical channels therefore has the same composition for all optical channels.

A further embodiment of the device according to the invention is characterized in that the contact part has optical characteristics chosen such that the contact part scatters the excitation light and the fluorescence light. This embodiment has the advantage that it allows the light generated by the calibration device to reach all detection positions with the same composition. Light generated by the calibration light source and going through the contact part is scattered such that it reaches all detection positions with the same composition.

According to the invention the medical image acquisition device comprises:

a) a measurement volume for accommodating the turbid medium;
b) a light source for irradiating the turbid medium;
c) a photodetector unit for detecting light emanating from the measurement volume,

characterized in that

the light source is arranged to emit excitation light chosen such that the excitation light causes a fluorescent agent present in the turbid medium to emit fluorescence light and in that the device further comprises a calibration device arranged to be optically coupled to the measurement volume and comprising a calibration light source arranged to simultaneously generate the excitation light and further light corresponding to the fluorescence light.

According to the invention the calibration device is arranged to be inserted into a receptacle that comprises a measurement volume for receiving a turbid medium in a device for imaging an interior of a turbid medium, has a contact part comprising a contact surface that fits at least a part of the surface of the receptacle facing the measurement volume, and has a calibration light source arranged to simultaneously generate light that causes fluorescent emission in a fluorescent agent present in the turbid medium and further light corresponding to the fluorescence light.

These and other aspects of the invention will be further elucidated and described with reference to the drawings, in which:

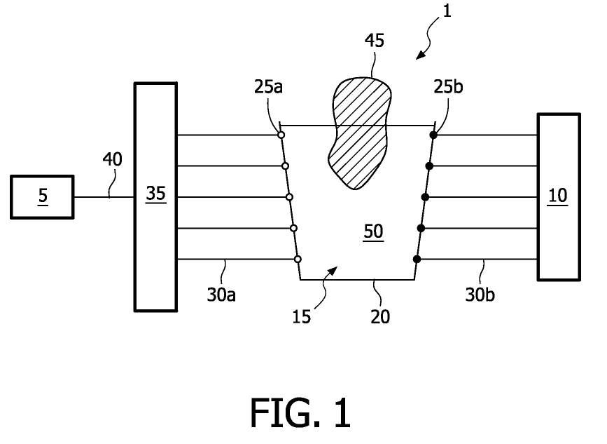

FIG. 1 shows embodiment of the device for imaging an interior of a turbid medium as known from prior art,

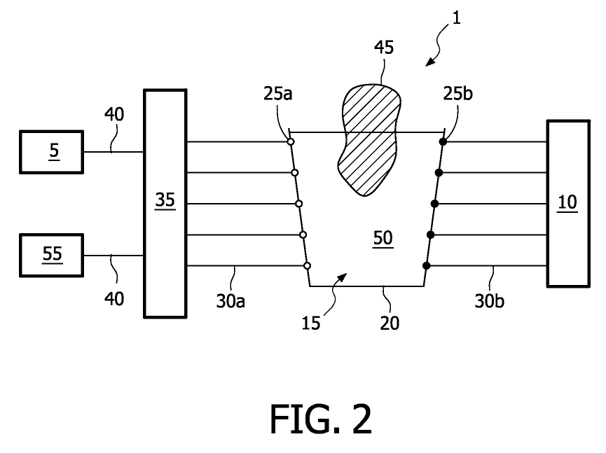

FIG. 2 schematically shows a calibration device arranged to be permanently integrated into a device for imaging an interior of a turbid medium,

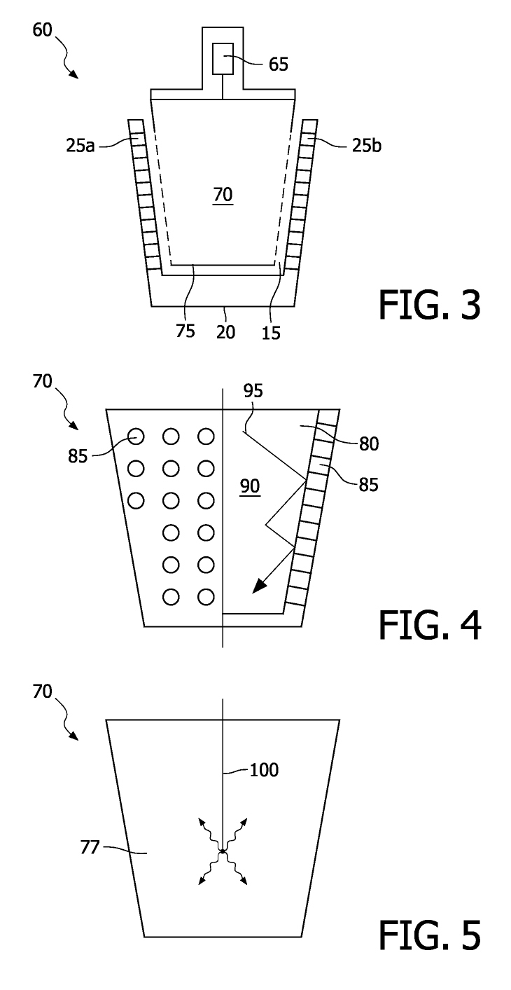

FIG. 3 schematically shows a calibration device arranged to be inserted into a device for imaging an interior of the turbid medium,

FIG. 4 schematically shows a contact part comprising a surface that reflects the excitation light and the fluorescence light and comprising further optical channels,

FIG. 5 schematically shows a contact part comprising a surface that weakly scatters the excitation light and the fluorescence light,

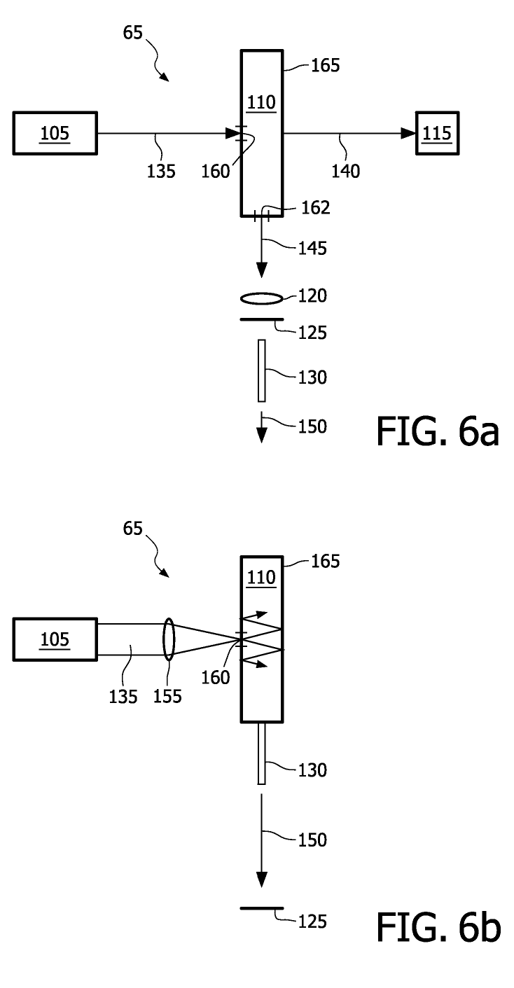

FIG. 6a schematically shows an embodiment of a calibration light source,

FIG. 6b schematically shows a further embodiment of a calibration light source.

FIG. 1 schematically shows a device 1 for imaging an interior of a turbid medium as known from prior art. The device 1 comprises a light source 5, a photodetector unit 10, a measurement volume 15 bound by a receptacle 20, said receptacle comprising a plurality of optical channels 25a and 25b, and light guides 30a and 30b coupled to said optical channels. The device 1 further includes a selection unit 35 for coupling the input light guide 40 to a number of optical channels selected from the plurality of optical channels 25a in the receptacle 20. For the sake of clarity, optical channels 25a and 25b have been positioned at opposite sides of the receptacle 20. In reality, however, both types of optical channel may be distributed around the measurement volume 15. A turbid medium 45 is placed inside the measurement volume 15. The turbid medium 45 is then irradiated with light from the light source 5 from a plurality of positions by coupling the light source 5 using the selection unit 35 to successively selected optical channels 25a. The light is chosen such that it is capable of propagating through the turbid medium 45. Light emanating from the measurement volume 15 as a result of irradiating the turbid medium 45 is detected from a plurality of positions using optical channels 25b and using photodetector 10. The detected light is then used to derive an image of an interior of the turbid medium 45. Deriving an image of an interior of the turbid medium 45 based on the detected light is possible as at least part of this light has traveled through the turbid medium 45 and, as a consequence, contains information relating to an interior of the turbid medium 45. The light was intentionally chosen such that it is capable of propagating through the turbid medium 45. In the measurement volume 15 the turbid medium 45 may at least partially be surrounded by a further medium 50 that may be used to counteract boundary effects stemming from the optical coupling of the turbid medium 45 with its surroundings. During measurements aimed at imaging an interior of the turbid medium 45 light capable of propagating through the turbid medium 45 must be coupled into the turbid medium 45 in a reproducible way without the occurrence of boundary effects like, for instance, reflections. The optical characteristics of the further medium 50 at least partially surrounding the turbid medium 45 inside the measurement volume 15 must be such that characteristics, such as, for instance, the absorption coefficient match those of the turbid medium 45 being imaged for the wavelengths of light used for imaging an interior of the turbid medium 45. By matching optical characteristics boundary effects are significantly reduced.

In FIG. 1 the measurement volume 15 is bound by a receptacle 20. However, this need not always be the case. Another embodiment of a device for imaging an interior of a turbid medium is that of a handheld device that may, for instance, be pressed against a side of a turbid medium. In that case, the measurement volume is the volume occupied by the part of the turbid medium from which light is detected as a result of irradiating the turbid medium.

FIG. 2 schematically shows a calibration device 55 arranged to be permanently integrated into a device 1 for imaging an interior of a turbid medium. Basically FIG. 2 is the same as FIG. 1. However, the light source 5 is arranged to emit excitation light chosen such that the excitation light causes a fluorescent agent present in the turbid medium 45 to emit fluorescence light and in that the device further comprises a calibration device 55. The calibration device 55 has been integrated into the device 1 analogously to the light source 5 for irradiating the turbid medium 45 known from prior art. Through the selection unit 35 the calibration device 55 can be optically coupled to the measurement volume 15. This embodiment has the advantage that it allows the calibration process to be performed fully automatically. During the calibration process the turbid medium 45 is not present in measurement volume 15. During the calibration process of a device 1 as shown in FIG. 2, light generated by the calibration device 55 is coupled to selection unit 35 through light guide 40 after which the light is coupled to a selected optical channel 25a chosen from the plurality of optical channels 25a. The light generated by the calibration device 55 must reach all optical channels 25b coupled to the photodetector unit 10 with the same composition. This can be achieved by accommodating a calibration medium in the receptacle 20 instead of a matching medium 50, with the calibration medium having optical properties chosen such that the calibration medium scatters the light generated by the calibration device 55 and that the calibration medium does not absorb the light generated by the calibration device 55. Which calibration medium is suitable depends on the optical characteristics of the light generated by the calibration device 55. If, for instance, the calibration device 55 comprises indocyanine green (ICG) as a fluorescent agent and the excitation light as a wavelength of 600-1000 nanometres, a mixture of water and titanium dioxide is a suitable calibration medium. The calibration device 55 need not be integrated into the device 1 analogously to the light source 5 for irradiating the turbid medium 45. Alternatively, the calibration device 55 may be inserted into the receptacle 20. In general, there will remain a space between the surface of the receptacle 20 facing the measurement volume 15 and an inserted calibration device 55. In that case, a calibration medium may again be used to ensure that the light generated by the calibration device 55 reaches all optical channels 25b with the same composition.

FIG. 3 schematically shows a calibration device 60 arranged to be inserted into a device 1 for imaging an interior of a turbid medium. The device 1 comprises a receptacle 20 comprising a measurement volume 15 for accommodating the turbid medium 45. As during a calibration measurement no turbid medium 45 is present in the measurement volume 15, no turbid medium 45 is shown in FIG. 3. The receptacle 20 further comprises optical channels 25a and 25b for optically coupling the measurement volume 15 to its surroundings. The calibration device 60 comprises a calibration light source 65 and a contact part 70. The contact part 70 comprises a contact surface 75 that closely fits at least a part of the surface of the receptacle 20 facing the measurement volume 15. The contact part 70 can be made to be exchangeable. This has the advantage that different contact parts can be used that fit different receptacles comprising measurement volumes having different dimensions.

FIG. 4 schematically shows a contact part 70 comprising a surface 80 that reflects the excitation light and the fluorescence light and comprising further optical channels 85. The left part of FIG. 4 schematically shows the outside of the contact part 70, whereas the right part of FIG. 4 schematically shows half a cross-section of the contact part 70. The contact part 70 is arranged to be comprised in the calibration device 60 such that the contact part 70 comprises a surface 80 bounding a contact part volume 90 and facing the calibration light source 65. This surface 80 has optical characteristics chosen such that the surface 80 reflects the excitation light and the fluorescence light. These characteristics enable multiple reflections inside the contact part volume 90 bound by the surface 80. The multiple reflections are illustrated by light ray 95. The contact part 70 further comprises further optical channels 85 for optically coupling the calibration device 60 to selected optical channels 25b in the receptacle 20 comprised in the device 1. Because of the reflecting optical characteristics of the surface 80 bounding a contact part volume 90 and facing the calibration light source 65, the light generated by the calibration device 60 and reaching the further optical channels 85 has the same intensity and composition for all further optical channels 85. The surface 80 bounding a contact part volume 90 and facing the calibration light source 65 can be made to have suitable optical properties by, for instance, coating it with gold.

FIG. 5 schematically shows a contact part 70 comprising a scattering volume 77 that weakly scatters the excitation light and the fluorescence light. The contact part 70 comprises a scattering volume 77 that has optical characteristics chosen such that the scattering volume 77 weakly scatters the excitation light and the fluorescence light as shown schematically at 100. The scattering volume 77 can be made to have suitable optical properties by, for instance, making it from a mixture of epoxy and titanium dioxide. If a mixture of epoxy and titanium dioxide is chosen it may be cast in liquid form around the end of an optical fiber 100. Once hardened, light emanating from the end of the optical fiber 100 is weakly scattered in the scattering volume 77.

FIG. 6a schematically shows an embodiment of a calibration light source 65. The calibration light source 65 comprises a light source 105 for irradiating the contents of a cuvette 110 comprising a fluorescent agent, a beam stop 115, collection optics 120 for collecting light emanating from the cuvette 110, an optional absorption filter 125 for absorbing light emitted by the light source 105, and an optical fiber 130 for coupling light out of the calibration light source 65. Light source 105 which may, for instance, be a laser beam emits a light beam 135. The light beam 135 then reaches the cuvette 110 that comprises a fluorescent agent. The light emitted by light source 105 is chosen such that the light causes the fluorescent agent present in the cuvette 110 to emit fluorescence light. Light emanating from the cuvette 110 in a direction parallel to that of the light beam 135, that is light beam 140, is stopped by beam stop 115. In a direction perpendicular to the direction of the light beam 135, a light beam 145 comprising a combination of scattered light emitted by the light source 105 and fluorescence light emanates from the cuvette 110. The light beam 145 then passes through the collection optics 120 and, optionally, through an absorption filter 125 for absorbing light emitted by the light source 105. After that, light from light beam 145 enters the optical fiber 130. The optical fiber 130 is used to couple light beam 150 out of the calibration light source 65. The cuvette 110 comprises a boundary 165 facing the dye volume that optionally has optical properties chosen such that at least part of the boundary 165 reflects the light emitted by the light source 105. If this option is chosen, light from the light source 105 may enter the cuvette 110 through an optical opening 160 in the wall of the cuvette 110 and exit the cuvette 110 through a further optical opening 162 in the wall of the cuvette 110. The boundary 165 can be made to reflect the light emitted by the light source 105 by, for instance, coating the boundary 165 with a gold layer.

FIG. 6b schematically shows a further embodiment of a calibration light source 65. The calibration light source 65 comprises a light source 105 for irradiating the contents of a cuvette 110 comprising a fluorescent agent, focusing optics 155 for focusing the light emitted by the light source 105 unto an optical opening 160 in the wall of the cuvette 110, an optional absorption filter 125 for absorbing light emitted by the light source 105, and an optical fiber 130 for coupling light out of the calibration light source 65. Light source 105 which may, for instance, be a laser beam emits a light beam 135. The light beam 135 is then focused by focusing optics 155 unto an optical opening 160 in the wall of cuvette 110. Through the optical opening 160 the light beam 135 irradiates the contents of the cuvette 110. The light emitted by light source 105 is chosen such that the light causes the fluorescent agent present in the cuvette 110 to emit fluorescence light. The cuvette 110 comprises a boundary 165 facing the volume comprising the fluorescent agent that has optical properties chosen such that the boundary 165 reflects the light emitted by the light source 105. In this way, the path traveled by the light emitted by the light source 105 inside the cuvette 110 is lengthened. This results in more fluorescence light being produced. The boundary 165 can be made to reflect the light emitted by the light source 105 by, for instance, coating the boundary 165 with a gold layer. In a direction perpendicular to the direction of the light beam 135, an optical fiber 130 coupled to the cuvette 110 is used to couple a light beam 150 out of the cuvette 110. The light beam 150 comprises a combination of scattered light emitted by the light source 105 and fluorescence light generated in the cuvette 110. The light beam 150 then optionally passes through an absorption filter 125 for absorbing light emitted by the light source 105.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. In the system claims enumerating several means, several of these means can be embodied by one and the same item of computer readable software or hardware. The mere fact that certain measures are recited in mutually different dependent claims does not indicate that a combination of these measures cannot be used to advantage.

1. A device for imaging an interior of a turbid medium comprising:
a) a measurement volume (15) for accommodating the turbid medium (45);
b) a light source (5) for irradiating the turbid medium (45);
c) a photodetector unit (10) for detecting light emanating from the measurement volume (15),
characterized in that
the light source (5) is arranged to emit excitation light chosen such that the excitation light causes a fluorescent agent present in the turbid medium (45) to emit fluorescence light and in that the device (1) further comprises a calibration device (60) arranged to be optically coupled to the measurement volume (15) and comprising a calibration light source (65) arranged to simultaneously generate the excitation light and further light corresponding to the fluorescence light.

2. A device as claimed in claim 1, characterized in that the calibration device (55, 60) comprises a fluorescent dye.

3. A device as claimed in claim 2, characterized in that the fluorescent dye is comprised inside a dye volume having boundaries facing the dye volume that have optical characteristics chosen such that the boundaries reflect the excitation light.

4. A device as claimed in claim 1, characterized in that the calibration device (60) further comprises adjusting means arranged to adjust the relative intensities of the excitation light and the further light generated by the calibration device (60).

5. A device as claimed in claim 1, characterized in that the calibration device (60) is arranged to be inserted into the device.

6. A device as claimed in claim 1, characterized in that the device further comprises a receptacle (20) comprising the measurement volume (15) for accommodating the turbid medium (45), said receptacle (20) comprising optical channels (25a, 25b) for optically coupling the light source (5) to the measurement volume (15) and the measurement volume (15) to the photodetector unit (10), the calibration device (60) being arranged to be inserted into the receptacle (20) and the calibration device (60) comprising a contact part (70) comprising a contact surface (75) that fits at least a part of the surface of the receptacle (20) facing the measurement volume (15).

7. A device as claimed in claim 6, characterized in that the contact part (70) is removable.

8. A device as claimed in claim 7, characterized in that the contact part (70) comprises a surface (80) bounding a contact part volume and facing the calibration light source (65), said surface (80) having optical characteristics chosen such that the surface (80) reflects the excitation light and the fluorescence light, the surface (80) comprising further optical channels (85) for optically coupling the calibration device (60) to selected optical channels (25b).

9. A device as claimed in claim 7, characterized in that the contact part (70) has optical characteristics chosen such that the contact part scatters the excitation light and the fluorescence light.

10. A medical image acquisition device comprising:
a) a measurement volume (15) for accommodating the turbid medium (45);
b) a light source (5) for irradiating the turbid medium (45);
c) a photodetector unit (10) for detecting light emanating from the measurement volume (15),
characterized in that
the light source (5) is arranged to emit excitation light chosen such that the excitation light causes a fluorescent agent present in the turbid medium (45) to emit fluorescence light and in that the device further comprises a calibration device (60) arranged to be optically coupled to the measurement volume (15) and comprising a calibration light source (65) arranged to simultaneously generate the excitation light and further light corresponding to the fluorescence light.

11. A calibration device (60) arranged to be inserted into a receptacle (20) that comprises a measurement volume (15) for receiving a turbid medium (45) in a device for imaging an interior of a turbid medium (45), having a contact part (70) comprising a contact surface (75) that fits at least a part of the surface of the receptacle (20) facing the measurement volume (15), and having a calibration light source (65) arranged to simultaneously generate light that causes fluorescent emission in a fluorescent agent present in the turbid medium and further light corresponding to the fluorescence light.
